(19) United States
(12) Patent Application Publication
(10) Pub. No.: US 2012/0065555 A1
(43) Pub. Date: Mar. 15, 2012

(54) MASSAGE APPARATUS FOR SKIN CARE

(75) Inventors: JONG DEOK CHAE, Gwangju (KR); UN-CHAE JEONG, Gwangju (KR); Seon A. HWANG, Mokpo (KR)

(73) Assignee: Eun Suk LEE, Englewood Cliffs, NJ (US)

(21) Appl. No.: 13/228,129

(22) Filed: Sep. 8, 2011

(30) Foreign Application Priority Data
Sep. 10, 2010 (KR) 10-2010-0088856
Jul. 4, 2011 (KR) 10-2011-0066135

(51) Int. Cl. A61H 1/00; A61H 15/00

(52) U.S. Cl. 601/18; 601/112; 601/46

(57) ABSTRACT

Provided is a massage apparatus for skin care, which is designed to be bent by its rotation. The massage apparatus for skin care has an elongated body and a head at one end of the body to apply a stimulus to a skin. The body is divided into a head section in which the head is located, and a grip section opposite to the head section, along an inclined plane sloped with respect to a longitudinal direction of the body. The head section and the grip section separated from each other are connected to be rotatable around a rotary shaft, which is provided in parallel to a normal direction of the inclined planes, in either or both of left and right directions, in a state that the inclined planes thereof contact each other.

### CROSS-REFERENCE(S) TO RELATED APPLICATION AND CLAIM OF PRIORITY

This application claims the benefit of Korean Patent Application No. 10-2010-0088856, filed on Sep. 10, 2010, and Korean Patent Application No. 10-2011-0066135, filed on Jul. 4, 2011, in the Korean Patent and Trademark Office, which are hereby incorporated by reference in their entirety.

### BACKGROUND

1. Field of the Invention

The present invention relates to a massage apparatus for skin care, and more particularly, to a massage apparatus for skin care, which is designed to be bent by its rotation, whereby a volume of the massage apparatus is reduced while a user carries it with him or her, and the massage apparatus is easy to grip.

2. Description of the Related Art

In general, a skin structure is divided into a stratum corneum, a dermis (a stratum spinosum, a stratum granulosum, a basal layer), and a dermis appendage (a hair follicle, a hair, a sebaceous gland, a sweat gland, an eccrine gland). A skin has a variety of physiological functions, including a protective function, a thermoregulatory function, a sensory function, an absorptive function, an excretory function, and an emotion delivery function. A skin color is determined by melanin, carotene, hemoglobin, and so on.

A skin is aged and is more wrinkled due to the loss of elasticity and flexibility, the reduction in amount of moisture, and the reduction in skin regeneration capacity.

To solve the above problems, a skin care has been done in various manners. For example, nutrients are supplied by applying a massage cream to a skin, and at the same time, a moisturizer is applied to a skin so as to keep the skin moist through moisture supply.

When massaging a skin by applying makeup as described above, a person applies makeup with his or her hands, applies the makeup to the skin, and massages the skin while rubbing the makeup on the skin. In this case, if the person massages the skin while rubbing the skin with his or her hands, a physical stimulus slightly occurs on the skin. Hence, a great massage effect could not be expected.

Therefore, a massage apparatus has been used to help relaxing muscles and speed up metabolism by applying a physical stimulus to the skin when rubbing the skin to which a massage cream is applied. As a result, a user can have an elastic healthy skin.

Conventional massage apparatuses capable of giving a physical stimulus to the skin have been designed in various shapes. For example, a massage apparatus that is capable of irradiating far-infrared rays while rubbing a skin is disclosed in Korean Utility Model Publication No. 20-2010-0000861. Massage apparatuses that tap a skin by generating a vibration while rubbing the skin are disclosed in Korean Utility Model Publication No. 20-2010-0000267 and Korean Utility Model Registration No. 20-0289206.

Such a massage apparatus has a rod shape so that a user can grip it with his or her hand and rub a face with a massage head. If the massage apparatus has a straight rod shape, it is inconvenient to rub a face with a massage head. Therefore, the massage head is bent toward a user's face. However, a massage apparatus with a bent massage head is inconvenient to carry because it is large in volume.

### SUMMARY

An aspect of the present invention is directed to a massage apparatus for skin care, which is designed to be bent by its rotation, whereby a volume of the massage apparatus is reduced while a user carries it with him or her, and a user easily holds the massage apparatus and contacts a head on a user's face.

According to an embodiment of the present invention, there is provided a massage apparatus for skin care, which has an elongated body and a head at one end of the body to apply a stimulus to a skin, characterized in that the body is divided into a head section in which the head is located, and a grip section opposite to the head section, along an inclined plane sloped with respect to a longitudinal direction of the body, and the head section and the grip section separated from each other are connected to be rotatable around a rotary shaft, which is provided in parallel to a normal direction of the inclined planes, in either or both of left and right directions, in a state that the inclined planes thereof contact each other.

The body has a circular cross-section, and the head section is formed by cutting an edge section formed by the inclined plane thereof and an outer plane that are met at an acute angle.

Switch contact points are formed on the inclined planes of the head section and the grip section, such that the switch contact points are contacted and electrically connected by a relative rotation of the head section and the grip section.

The head section or the grip section includes a lamp for mode display, which emits light by the connection of the switch contact points.

The head section includes a vibrating unit for generating a vibration to the head section, and the head section applies a tapping stimulus to a skin by transferring the vibration generated by the vibrating unit to the skin.

The head section includes a lamp for skin stimulus, and light emitted from the lamp for skin stimulus is irradiated through a front end of the head section.

The head section or the grip section includes an electric stimulus generating unit, partial or entire surfaces of the head section and the grip section are made of an electrically conductive material, and the surfaces made of the electrically conductive material are connected to two electrodes of the electric stimulus generating unit.

The head section includes: a lower section case in which the head is provided at a front end and a board is mounted thereinside; and a rotary shaft section which is integrally connected to the head section case and in which an inclined plane contacting the inclined plane of the grip section is formed at an end portion thereof, the rotary shaft section including a rotary shaft protruding vertically with respect to the inclined plane. The grip section includes: a grip section case having an inclined plane contacting the inclined plane of the head section at an upper end thereof; and a shaft support section integrally connected to the grip section case such that the rotary shaft is inserted into and supported by the shaft support section at the upper end of the grip section case.

The head section further includes: a switching unit connected to the rotary shaft section such that the switching section is integrally rotated with the rotary shaft section, the switching unit having a terminal pin receiving groove; and a switching terminal pin received in the terminal pin receiving groove and having an end portion elastically supported in a protruding direction, wherein the grip section has a surface through which the end portion of the switching terminal pin contacts and passes, at least one switch contact point being formed on the surface of the grip section.

The board includes a lamp for mode display, and the rotary shaft section is made of a material through which light generated from the lamp for mode display is transmitted.

The rotary shaft section has a through-hole vertically penetrating through the central portion of the rotary shaft, and a wire for connecting the head section and the grip section passes through the through-hole.

### BRIEF DESCRIPTION OF THE DRAWINGS

FIG. 1 is a perspective view of a massage apparatus for skin care according to a first embodiment of the present invention.

FIG. 2 is an exploded perspective view of the massage apparatus according to the first embodiment of the present invention.

FIG. 3 is a side view of the massage apparatus according to the first embodiment of the present invention.

FIG. 4 is a front view of the massage apparatus according to the first embodiment of the present invention.

FIG. 5 is a front view conceptually showing a rotation of a head section of the massage apparatus according to the first embodiment of the present invention.

FIG. 6 is a view conceptually showing an electrical connection of the massage apparatus according to the first embodiment of the present invention.

FIG. 7 is a view conceptually showing a usage state of the massage apparatus according to the first embodiment of the present invention.

FIGS. 8A to 8D are exploded perspective views of a massage apparatus for skin care according to a second embodiment of the present invention.

FIGS. 9A to 9D are exploded perspective views showing a head section of the massage apparatus according to the second embodiment of the present invention.

FIGS. 10A to 10D are exploded perspective views showing a grip section of the massage apparatus according to the second embodiment of the present invention.

FIGS. 11A and 11B are partial cut-away sectional views of the massage apparatus according to the second embodiment of the present invention.

FIGS. 12A and 12B are views conceptually showing an electrical connection of the massage apparatus according to the second embodiment of the present invention.

### DETAILED DESCRIPTION

A massage apparatus for skin care according to exemplary embodiments of the present invention will be described below in detail with reference to the accompanying drawings.

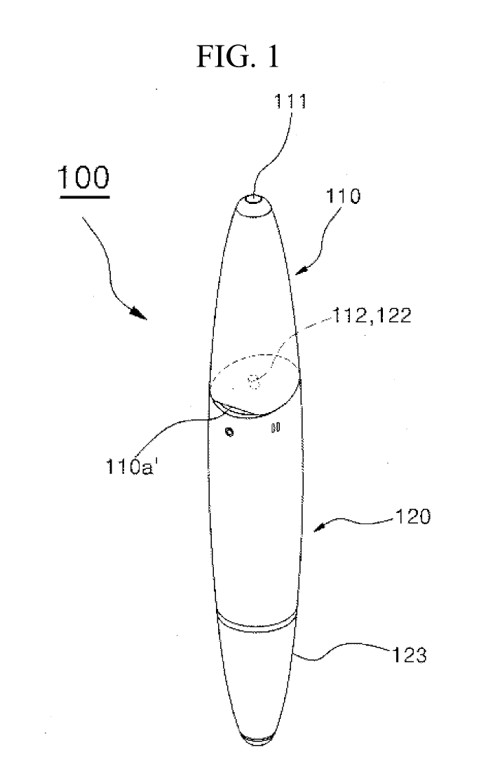

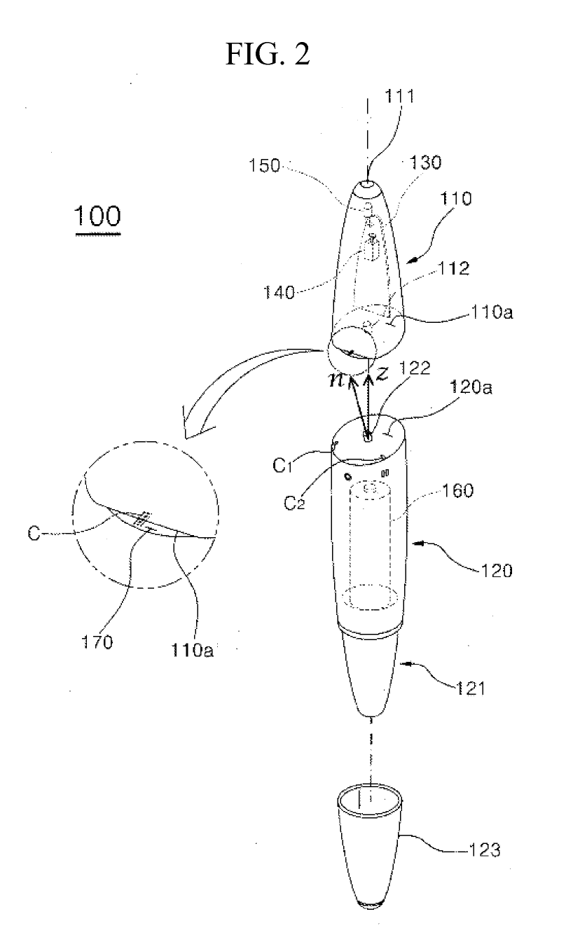

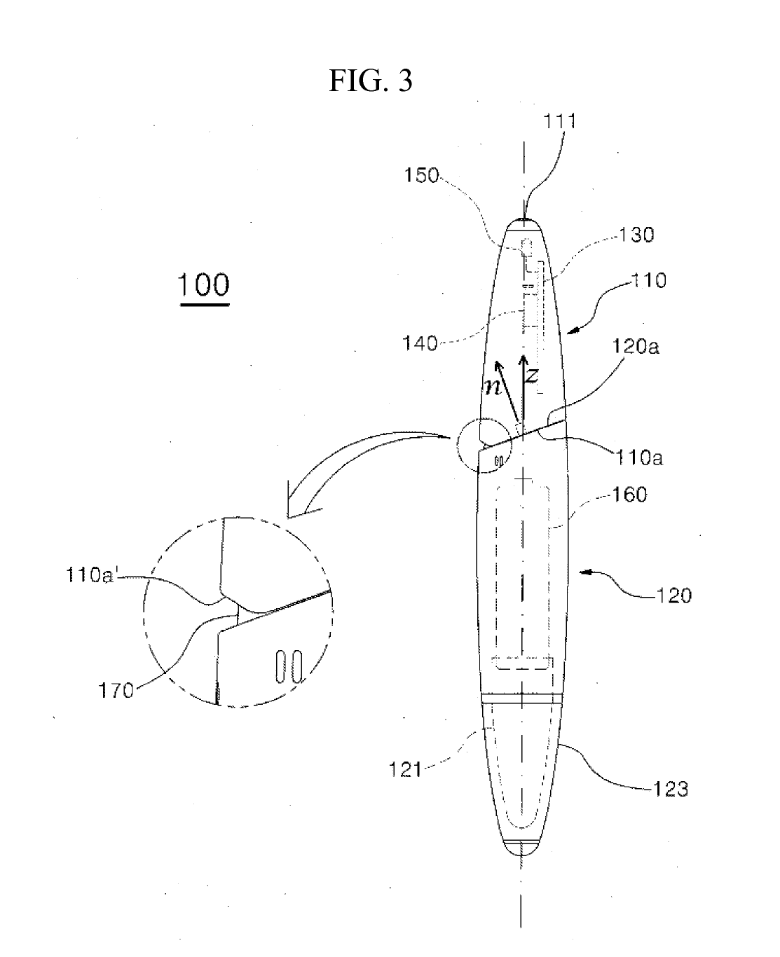

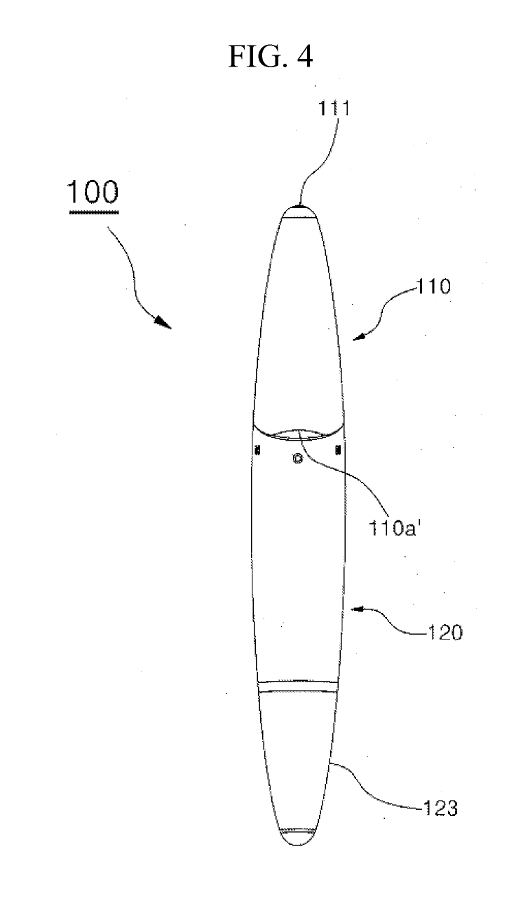

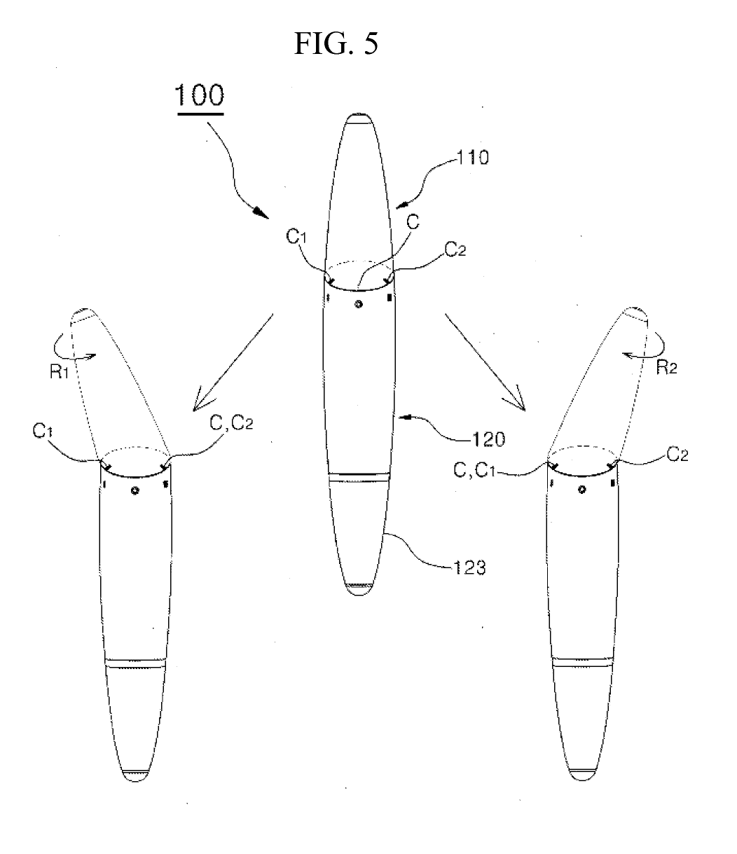

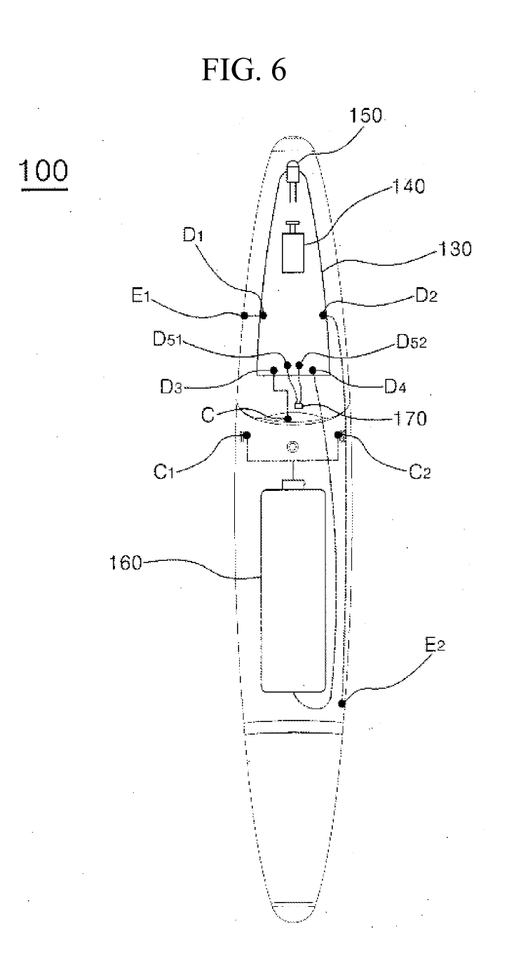

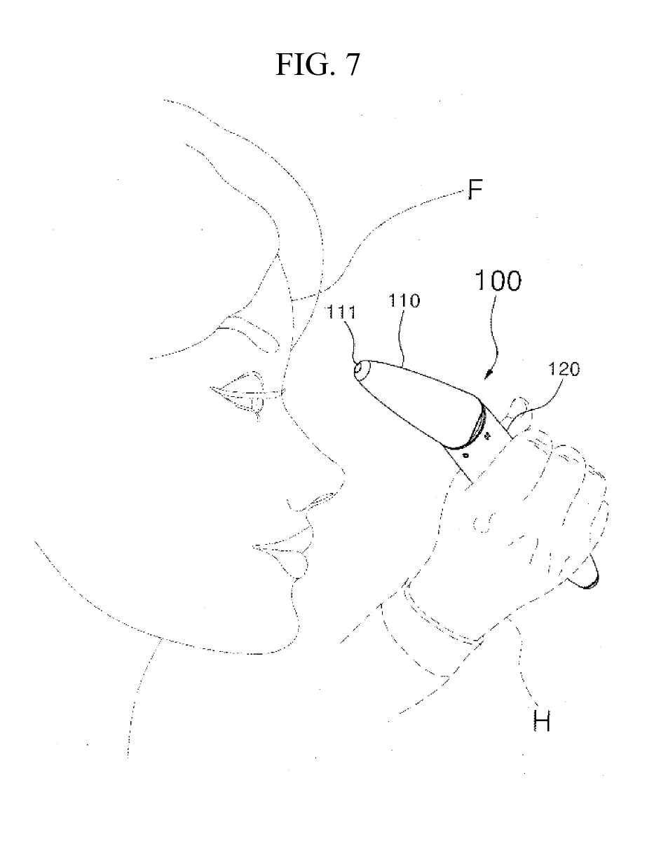

FIGS. 1 to 7 show a massage apparatus for skin care according to a first embodiment of the present invention. FIG. 1 is a perspective view of a massage apparatus for skin care according to a first embodiment of the present invention, and FIG. 2 is an exploded perspective view of the massage apparatus according to the first embodiment of the present invention. FIG. 3 is a side view of the massage apparatus according to the first embodiment of the present invention, and FIG. 4 is a front view of the massage apparatus according to the first embodiment of the present invention. FIG. 5 is a front view conceptually showing a rotation of a head section of the massage apparatus according to the first embodiment of the present invention, and FIG. 6 is a view conceptually showing an electrical connection of the massage apparatus according to the first embodiment of the present invention. FIG. 7 is a view conceptually showing a usage state of the massage apparatus according to the first embodiment of the present invention.

Referring to FIGS. 1 to 7, the massage apparatus 100 for skin care according to the first embodiment of the present invention includes an elongated body that is separated into a head section 110 in which a head 111 is located, and a grip section 120 opposite to the head section 110. The head section 110 and the grip section 120 are bent by a rotation. To this end, the head section 110 and the grip section 120 of the massage apparatus 100 according to the first embodiment of the present invention are separated from each other along inclined planes 110a and 120a sloped with respect to a longitudinal direction z of the body. In the head section 110 and the grip section 120 separated from each other, a rotary shaft 122 provided on the inclined pane 120a of the grip section 120 is inserted into a shaft support hole 112 provided on the inclined plane 110a of the head section 110, in parallel to a normal direction n of the inclined planes 110a and 120a in such a state that the inclined planes 110a and 120a contact each other. Therefore, the head section 110 and the grip section 120 are connected to be rotatable around the rotary shaft 122 in either or both of left and right directions. Since the head section 110 and the grip section 120 are rotated around the rotary shaft 122 sloped with respect to the longitudinal direction z of the body, central axes of the head section 110 and the grip section 120 are mismatched by a relative left/right rotation of the head section 110 and the grip section 120, and the head section 110 and the grip section 120 are bent at a predetermined angle therebetween. FIG. 5 conceptually shows a state in which the head section 110 and the grip section 120 are bent by their relative rotation. When the head section 110 and the grip section 120 are bent at a predetermined angle therebetween, it is convenient for a user to put the head 111 close to the skin of the face F while holding the grip section 120 with a hand H.

Meanwhile, when the body has a circular cross-section, the head section 110 and the grip section 120 rotate around the rotary shaft 122 in an inclined direction with respect to the longitudinal direction z of the body, that is, in the normal direction n of the inclined planes 110a and 120a, and an edge section 110a′ formed by the inclined plane 110a of the head section 110 and the outer plane met at an acute angle protrudes to hinder the use of the head section 110 and the grip section 120. Therefore, the head section 110 is designed such that the protrusion is not formed due to the rotation by cutting the edge section 110a′ formed by the inclined plane 110a of the head section 110 and the outer plane met at an acute angel.

The massage apparatus 100 according to the first embodiment of the present invention is provided with a device for skin massage in the body. A vibrating unit, such as a vibration motor 140, and a board 130 are provided inside the head section 110. The vibrating unit generates a vibration to the head section 110 so that the head 111 applies a tapping stimulus to a skin. A circuit for controlling the operation of the vibration motor 140 is formed on the board 130. A battery 160 for power supply is provided inside the grip section 120. The head section 110 applies a tapping stimulus to the skin by transferring the vibration generated by the vibrating unit from the head 111 to the skin.

In addition, the head section 110 is provided with a lamp 150 for skin stimulus. Light generated from the lamp 150 is irradiated to a front end of the head through a light transmission window provided at the front end of the head 111, and is applied to the skin.

On the board 130 provided inside the head section 110, the vibration motor 140 and the lamp 150 for skin stimulus are installed, and a circuit for driving the vibration motor 140, the lamp 150 for skin stimulus, and a lamp 170 for mode display (which will be described below) is also formed.

Meanwhile, the massage apparatus 100 for skin care according to the first embodiment of the present invention may further include an electric stimulus generating unit (not shown) provided in the head section 110 or the grip section 120 to apply electric stimulus, such as electric pulse, to the skin. The electric stimulus generating unit may be provided on the board 130 provided inside the head section 110. In order to apply the electric stimulus generated by the electric stimulus generating unit to the human body, the surfaces of the head section 110 and the grip section 120 are made of an electrically conductive material so that an electric current can flow by a user's skin contact. That is, the surfaces of the head section 110 and the grip section 120 may be coated with an electrically conductive material, e.g., aluminum, or the head section 110 and the grip section 120 may be made of a metallic material so that the surfaces thereof become electrically conductive. Thus, an electric current can flow upon skin contact. The surfaces of the head section 110 and the grip section 120 are connected to both terminals of the electric stimulus generating unit. The vibration motor 140, the lamp 150 for skin stimulus, the electric stimulus generating unit, the surfaces of the head section 110 and the grip section 120, the lamp 170 for mode display, the switch contact points C, C1 and C2, and the battery 160 (which will be described below), which are provided on the board 2, are electrically connected as shown in FIG. 6. A switching unit for switching the electrical connection to select an operation mode is provided in the body. The switching unit may be mounted on the body in various manners. As shown, the switching unit may be configured to perform a switching operation by a relative rotation of the head section 110 and the grip section 120. Specifically, the switch contact points C, C1 and C2 are formed on the inclined planes 110a and 120a of the head section 110 and the grip section 120. When the head section 110 and the grip section 120 are relatively rotated by the bending of the head section 110 and the grip section 120, the switch contact points C, C1 and C2 are contacted and electrically connected together. Referring to FIGS. 2 and 5, when the body is in a straight form, that is, there is no relative rotation between the head section 110 and the grip section 120, the switch contact point C provided on the inclined plane 110a of the head section 110 is located between the switch contact points C1 and C2 provided on the left and right of the inclined plane 120a of the grip section 120. Thus, the switch contact point C is separated from the switch contact points C1 and C2, and the electrical connection is broken. As shown in the left side of FIG. 5, if the head section 110 is rotated in a counterclockwise direction R1 with respect to the grip section 120, the switch contact point C provided on the inclined plane 110a of the head section 110 is moved to the right and is contacted with the switch contact point C2 provided on the right position of the inclined plane 120a of the grip section 120, thereby establishing the electrical connection. On the contrary, as shown in the right side of FIG. 5, if the head section 110 is rotated in a clockwise direction R2 with respect to the grip section 120, the switch contact point C provided on the inclined plane 110a of the head section 110 is moved to the left and is contacted with the switch contact point C1 provided on the left position of the inclined plane 120a of the grip section 120, thereby establishing the electrical connection.

For example, in the case where a vibration mode by the vibration motor 130 is first and second vibration modes, if the head section 110 is rotated in a counterclockwise direction R1 as shown in the left side of FIG. 5, the head section 110 of the body is bent in a left direction, and the switch contact point C provided on the inclined plane 110a of the head section 110 contacts the switch contact point C2 provided on the right position of the inclined plane 120a of the grip section 120. Therefore, the circuit formed on the board 130 and the battery 160 are electrically connected together so that the massage apparatus operates in a first operation mode.

On the other hand, if the head section 110 is rotated in a clockwise direction R2 as shown in the right side of FIG. 5, the head section 110 of the body is bent in a right direction, and the switch contact point C provided on the inclined plane 110a of the head section 110 contacts the switch contact point C1 provided on the left position of the inclined plane 120a of the grip section 120. Therefore, the circuit formed on the board 130 and the battery 160 are electrically connected together so that the massage apparatus operates in a second operation mode.

Meanwhile, in order to display the operation mode (the first operation mode or the second operation mode) of the switching unit, the lamp 170 for mode display is provided at the head section 110 or the grip section 120, preferably, the head section 110 where the board 130 is disposed. The lamp 170 for mode display emits light to a gap between the inclined planes 110a and 120a of the head section 110 and the grip section 120. The lamp 170 for mode display emits light by the connection of the switch contact points C, C1 and C2. Referring to FIGS. 2 and 3, the lamp 170 for mode display may be exposed to the edge section 110a′ formed by cutting the inclined plane 110a of the head section 110 met at an acute angle. The lamp 170 for mode display may be configured with an LED lamp that emits different colors according to the first and second operation modes selected by the operation of the switching unit.

Meanwhile, FIG. 6 conceptually shows the electrical connection of the massage apparatus for skin care according to the first embodiment of the present invention. Referring to FIG. 6, one of the two terminals of the battery 160 is connected to a fourth connection contact point D4 provided in the head section 110, and the other is connected to the switch contact points C1 and C2 provided in the grip section 120. The switch contact point C provided in the head section 110 is connected to a third connection contact point D3 provided in the board 130. Therefore, the power of the battery 160 is supplied to the board 130 by the connection of the switch contact points C, C1 and C2 through the relative rotation of the head section 110 and the grip section 120.

In addition, one terminal of the electric stimulus generating unit provided in the board 130 is connected to a first surface contact point E1 provided on the surface of the head section 110 through a first connection contact point D1 provided in the board 130, and the other is connected to a second surface contact point E2 provided on the surface of the grip section 120 through a second connection contact point D2 provided in the board 130. As shown in FIG. 7, if the user holds the grip section 120 with his or her hand H and contacts the head 111 of the head section 110 on the skin of his or her face F, an electric current flows through the user's body and electric stimulus is applied to the skin.

Furthermore, a pair of fifth connection contact points D51 and D52 is provided in the board 130 and is connected to two terminals of the lamp 170 for mode display, respectively.

Meanwhile, persons often apply a massage liquid, such as a cream, to a skin in order for skin massage. The massage apparatus for skin care according to the first embodiment of the present invention is provided with a container 121 for containing a massage liquid, such as a cream. As shown, the container 121 is connected to a lower end of the grip section 120, and a cap 123 covers the exterior of the container 121. The container 121 may be integrally formed with the grip section 120, or may be detachable from the grip section 120. Therefore, if the massage liquid contained in the container 121 is used up, the container 121 is separated from the grip section 120 and a new container is connected to the grip section 120.

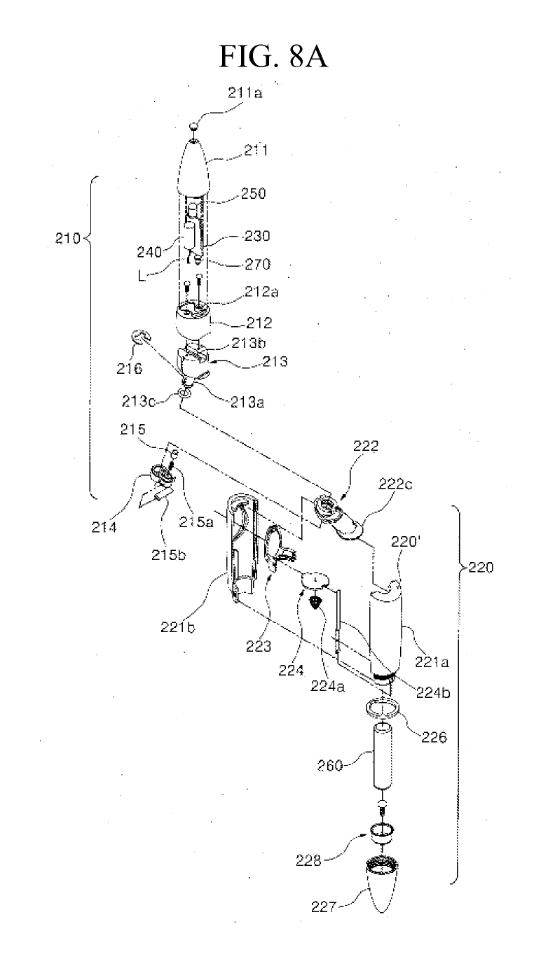

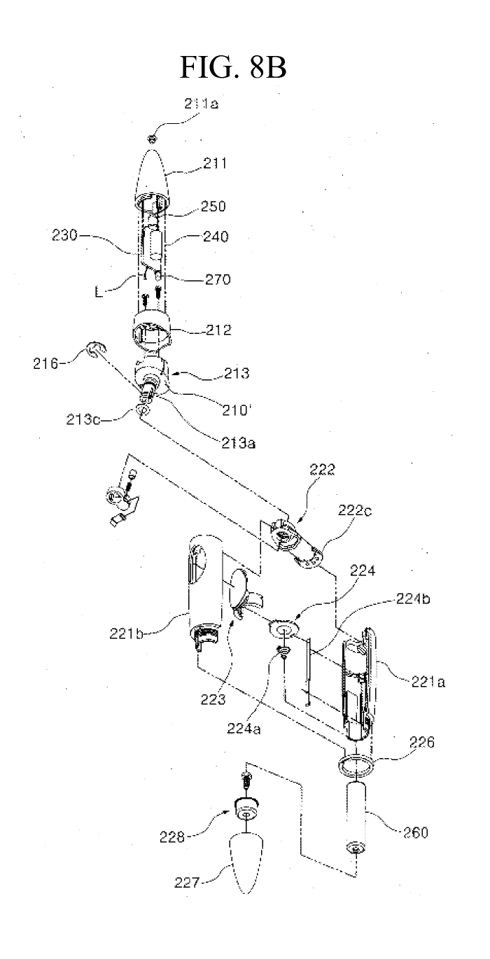

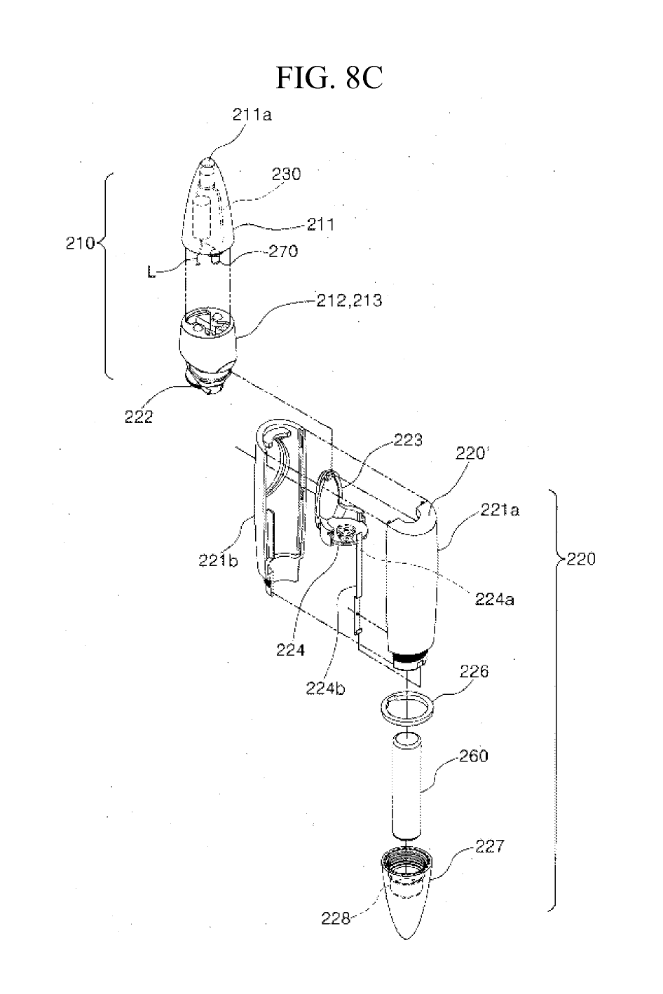

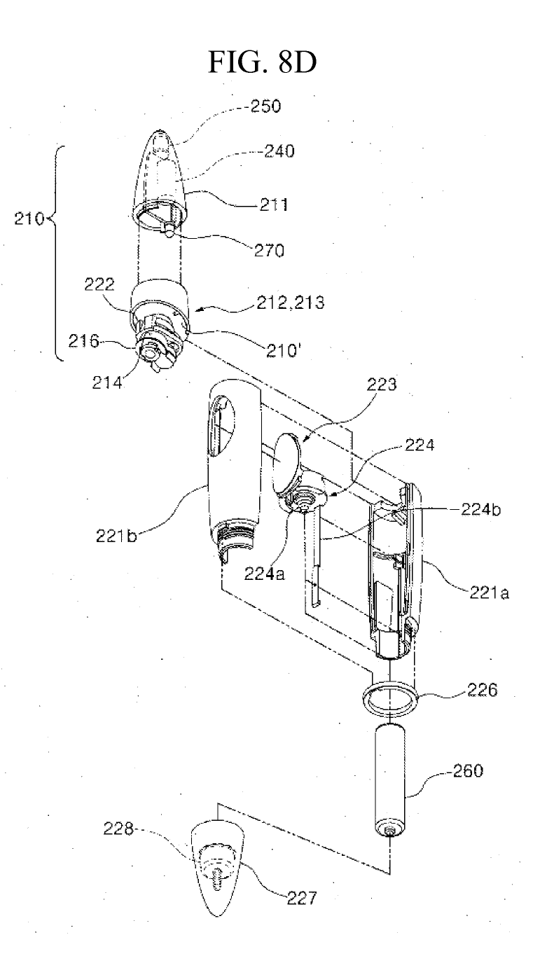

A massage apparatus for skin care according to a second embodiment of the present invention will be described below in detail with reference to FIGS. 8A to 12B.

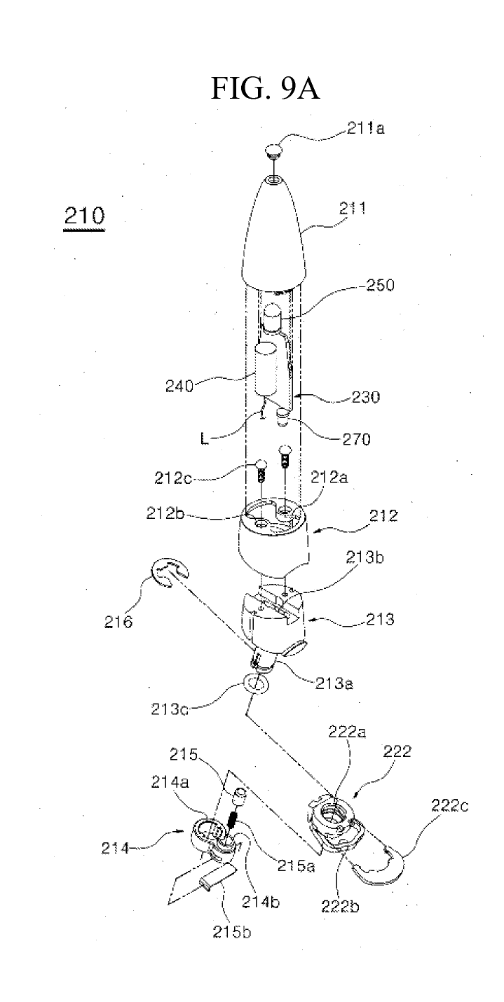

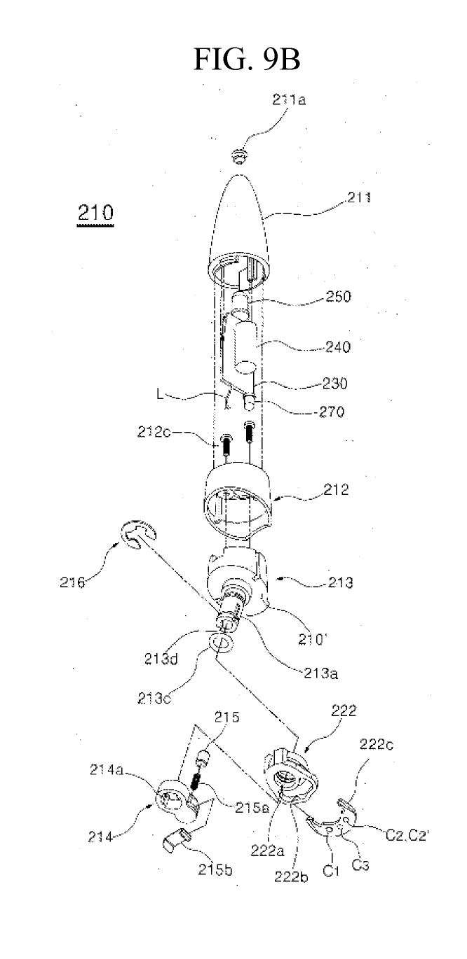

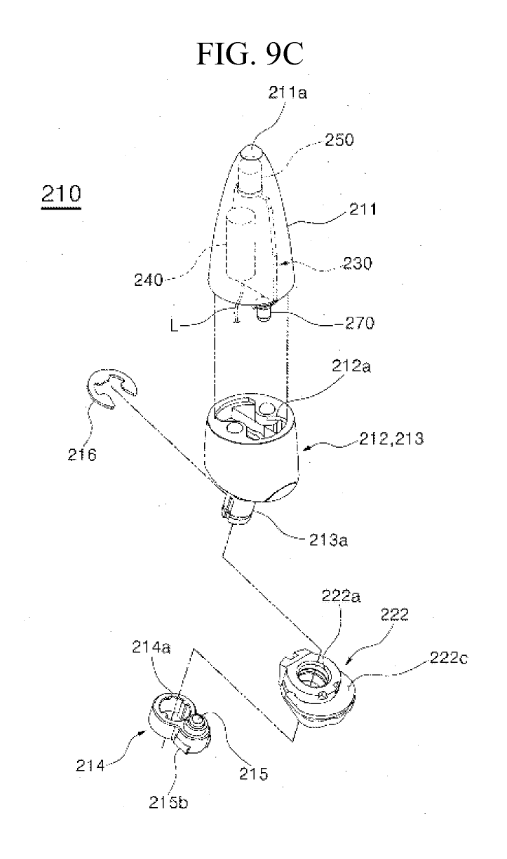

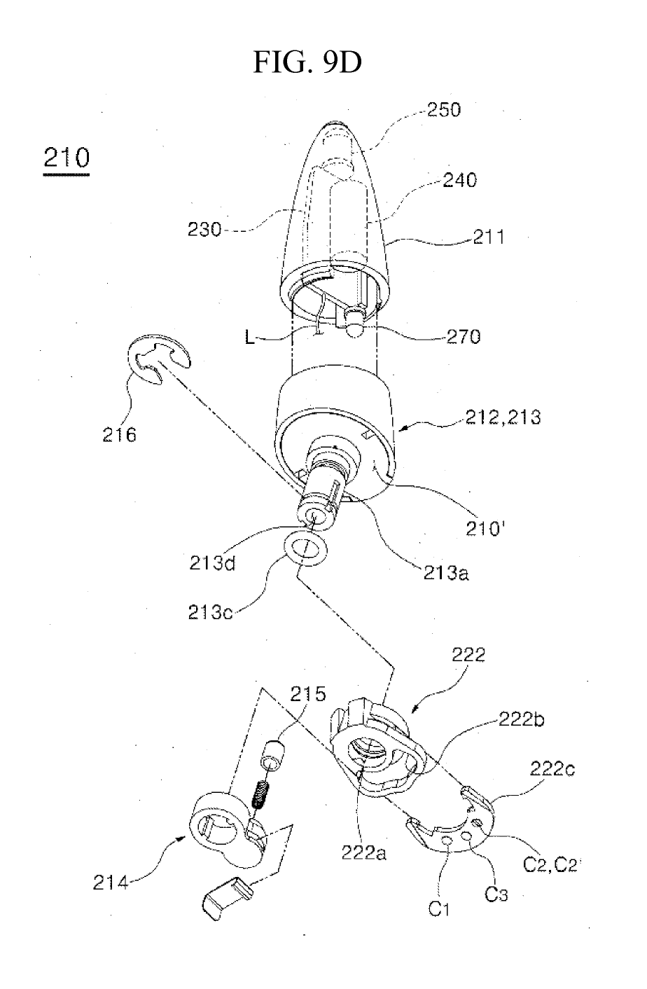

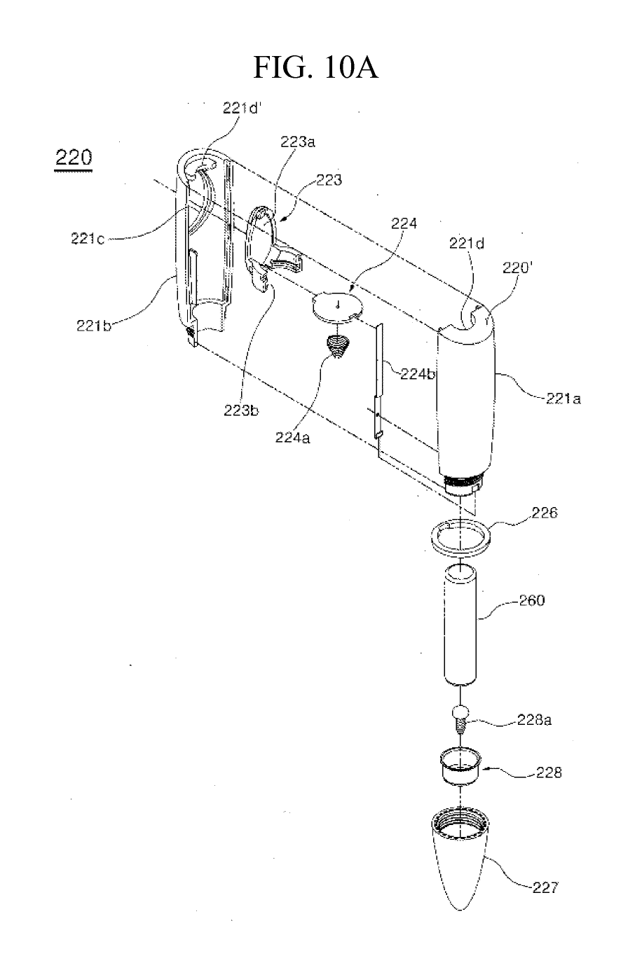

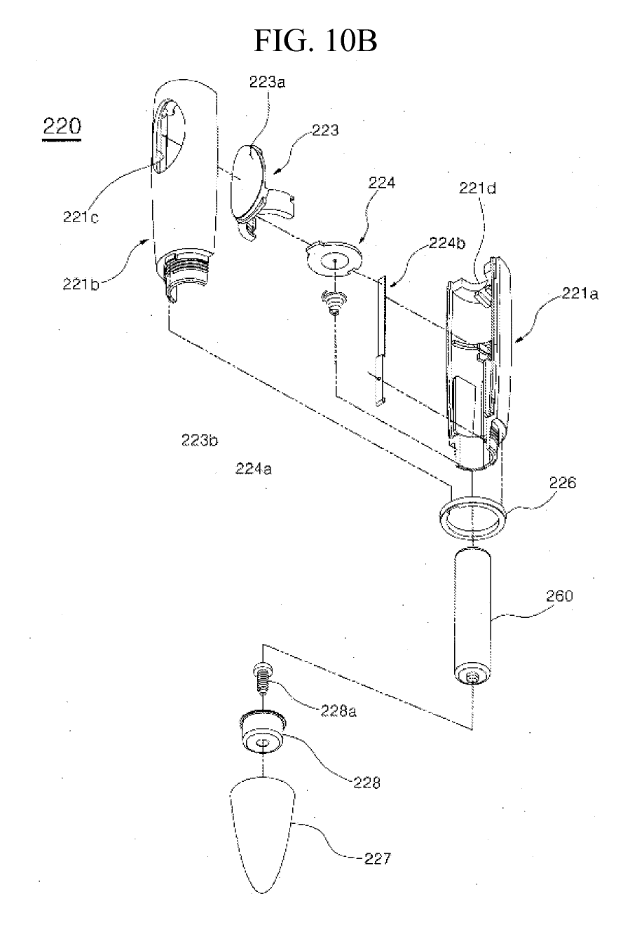

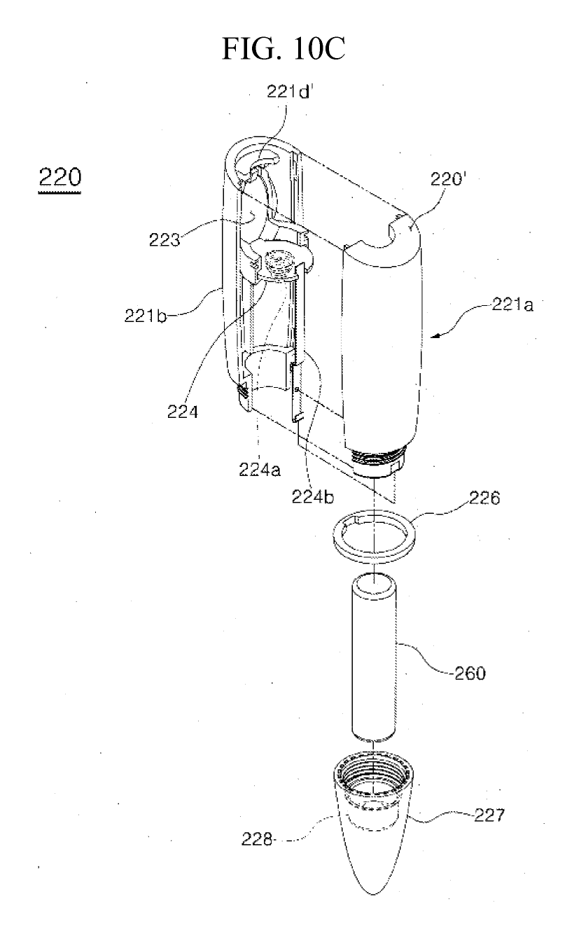

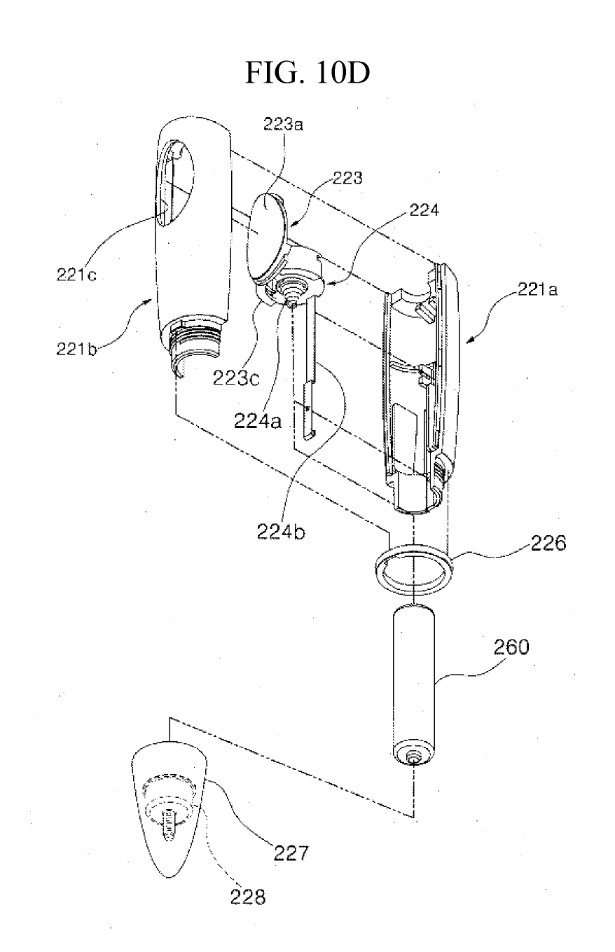

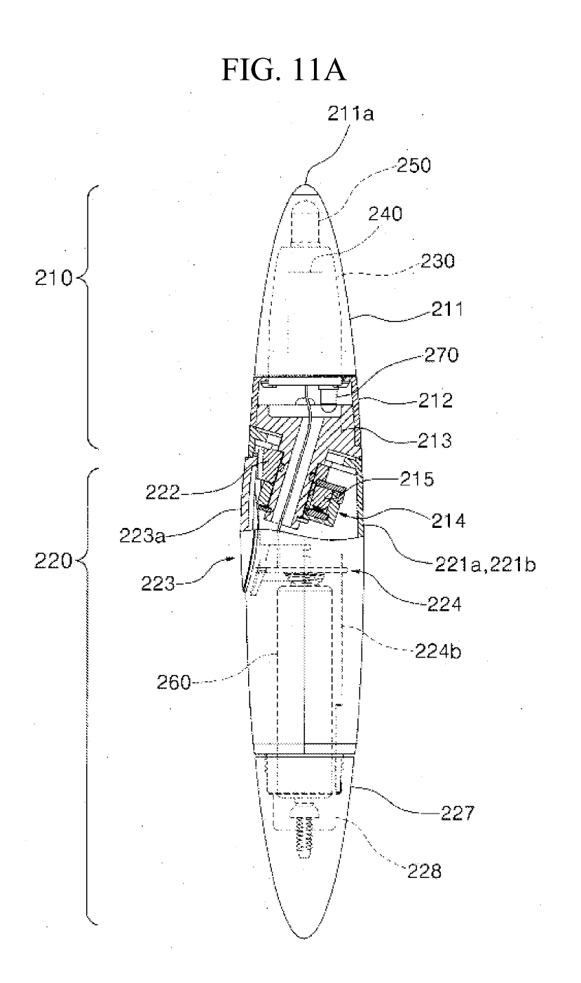

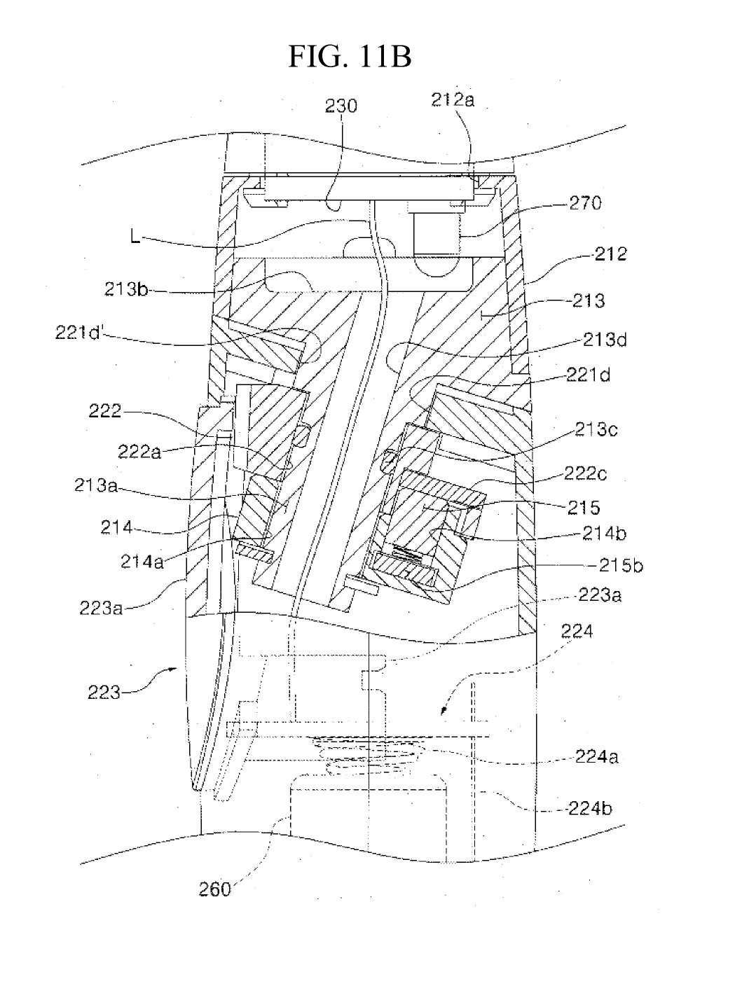

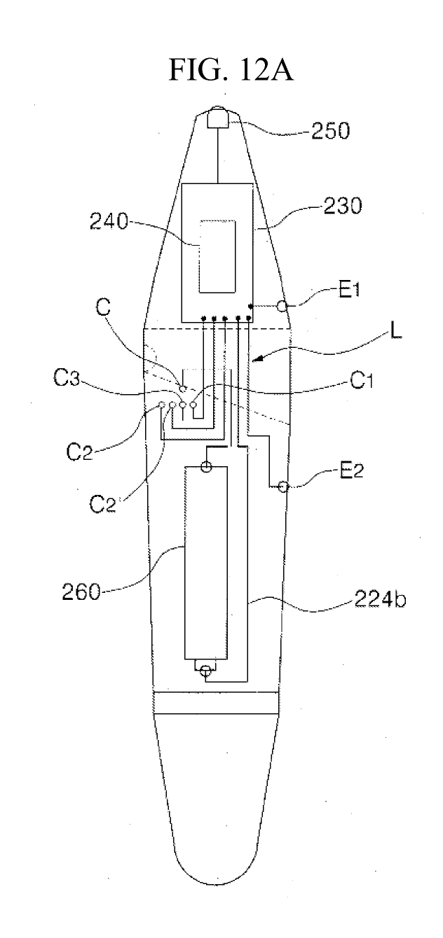

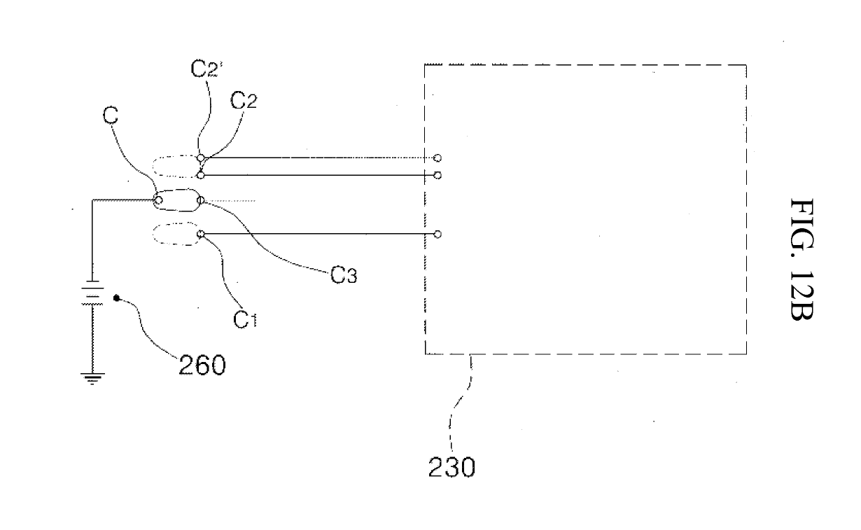

FIGS. 8A to 8D are exploded perspective views of a massage apparatus for skin care according to a second embodiment of the present invention, and FIGS. 9A to 9D are exploded perspective views showing a head section of the massage apparatus according to the second embodiment of the present invention. FIGS. 10A to 10D are exploded perspective views showing a grip section of the massage apparatus according to the second embodiment of the present invention, and FIGS. 11A and 11B are partial cut-away sectional views of the massage apparatus according to the second embodiment of the present invention. FIGS. 12A and 12B are views conceptually showing an electrical connection of the massage apparatus according to the second embodiment of the present invention.

Like in the first embodiment 100, the massage apparatus 200 shown in FIGS. 8A to 12B according to the second embodiment of the present invention includes an elongated body that is separated into a head section 210 in which a head 211a is located, and a grip section 220 opposite to the head section 210. The head section 210 and the grip section 220 are bent by a rotation. That is, the head section 210 and the grip section 220 of the massage apparatus 200 according to the second embodiment of the present invention are separated from each other along inclined planes 210′ and 220′ sloped with respect to a longitudinal direction of the body. The head section 210 and the grip section 220 separated from each other are connected to be rotatable around a rotary shaft 213a in either or both of left and right directions, wherein the rotary shaft 213a is provided in parallel to a normal direction of the inclined planes 210′ and 220′ in such a state that the inclined planes 210′ and 220′ contact each other. Since the head section 210 and the grip section 220 are rotated around the rotary shaft 213a sloped with respect to the longitudinal direction of the body, central axes of the head section 210 and the grip section 220 are mismatched by a relative left/right rotation of the head section 210 and the grip section 220, and the head section 210 and the grip section 220 are bent at a predetermined angle therebetween. A state in which the head section 210 and the grip section 220 are bent by their relative rotation is substantially identical to that that of the massage apparatus 100 of the first embodiment as shown in FIG. 5.

A following description will be made on the massage apparatus 200 for skin care according to the second embodiment of the present invention, in which the head section 210 and the grip section 220 are connected to be bent by their relative rotation.

The head section 210 is configured such that the head 211a applies a tapping stimulus to a skin and applies a skin stimulus to a skin by light. The head section 210 has a circular cross-section and has a streamlined shape, whose cross-sectional diameter becomes smaller toward the head 211a. As shown, the head section 210 includes a head section case 211, a connection cover 212, a rotary shaft section 213, a switching section 214, and a switching terminal pin 215. The head section case 211 is provided with the head 211a at a front end, and a board 230 is mounted inside the head section case 211. The connection cover 212 is connected to a lower end of the head section case 211 to cover the lower end of the head section case 211. The connection cover 212 connects the rotary shaft section 213 (which will be described below) to the head section case 211 such that they are integrated. The rotary shaft section 213 is connected to the connection cover 212 so that it is integrally connected to the head section case 211. An inclined plane 210′ contacting the inclined plane 220′ of the grip section 220 is formed at an end of the rotary shaft section 213. The rotary shaft section 213 is provided with a rotary shaft 213a protruding vertically with respect to the inclined plane 210′. The switching unit 214 is connected to the rotary shaft section 213 such that it is integrally rotated with the rotary shaft section 213. A terminal pin receiving groove is formed in the switching section 214. The switching terminal pin 215 is received at the terminal pin receiving groove and is elastically supported in a direction in which its end protrudes.

A vibrating unit, such as a vibration motor 240, and a board 230 are provided inside the head section case 210 having the head 211a at the front end. The vibrating unit generates a vibration so that a tapping stimulus is applied to a skin contacting the head 211a. A circuit for controlling the operation of the vibration motor 240 is formed on the board 230. In order to apply a light stimulus to the skin contacting the head 211a, a lamp 250 for skin stimulus is provided on the board 230 to irradiate light through the head 211a. A circuit for driving the lamp 250 for skin stimulus and a lamp 270 for mode display (which will be described below) is formed on the board 230. The head 211a is made of a light transmitting material so that light generated from the lamp 250 for skin stimulus is transmitted through the head 211a. Furthermore, in the massage apparatus 200 for skin care according to the second embodiment of the present invention, an electric stimulus generating unit (not shown) for applying electric stimulus, such as electric pulse, to the skin, is provided in the board 230. In order to apply the electric stimulus generated by the electric stimulus generating unit to the human body, the surfaces of the head section 210 and the grip section 220 are made of an electrically conductive material so that an electric current can flow by a user's skin contact. To this end, the surface of the head section 210 may be coated with an electrically conductive material, e.g., aluminum, or the head section 210 may be made of a metallic material so that the surface thereof becomes electrically conductive. Thus, an electric current can flow upon skin contact. The surface of the head section 210 is connected to one of two electrical terminals of the electric stimulus generating unit. In addition, a lamp 270 for mode display is provided in the board 230 received in the head section 210. The lamp 270 for mode display emits light according to an operation mode.

The connection cover 212 is connected to a lower end of the head section case 211 to cover the lower end of the head section case 211. The connection cover 212 connects the rotary shaft section 213 (which will be described below) to the head section case 211 such that they are integrated. As shown, the upper end of the connection cover 212 is connected to the lower end of the head section case 211 in a mechanical method, such as an adhesive or a hook, whereby the connection cover 212 is integrally connected to the head section case 211. The rotary shaft section 213 is integrally connected to a lower portion of the connection cover 212. Meanwhile, a through-hole 212a is vertically formed in the central portion of the connection cover 212. A wire L for electrical connection between the head section 210 and the grip section 220 passes through the through-hole 212a. Specifically, the wire L is connected from the board 230 received in the head section case 211 to the electrode of the battery 260 provided in the grip section 220 or the electrical contact point such as an electrode surface 223a. In addition, screw holes 212b are formed on both sides of the through-hole 212a. Screws 212c for connection to the rotary shaft section 213 are inserted into the screw holes 212b. Meanwhile, the connection cover 212 is made of a light transmitting material with the rotary shaft section 213, so that light generated from the lamp 270 provided in the board 230 can be transmitted to the exterior.

The rotary shaft section 213 has the inclined plane 210′ and the rotary shaft 213a. The inclined plane 210′ contacts the inclined plane 220′ provided on the grip section 220. The rotary shaft 213a is connected to a shaft support section 222 provided in the grip section 220 when the inclined planes 210′ and 220′ contact each other. The rotary shaft section 213 is connected to the connection cover 212 by the screw 212c so that it is integrally connected to the head section case 211. The inclined plane 210′ contacting the inclined plane 220′ of the grip section 220 is formed at a lower end of the connection cover 212. The rotary shaft 213a protrudes vertically with respect to the inclined plane 210′. The rotary shaft 213a is inserted into a shaft insertion hole 222a formed in the shaft support section 222 of the grip section 220. A friction ring 213c is disposed between the rotary shaft 213a and the shaft insertion hole 222a in order to ensure a friction greater than a predetermined level between the shaft insertion hole 222a and the rotary shaft 213c. Meanwhile, as described above, a through-hole 213b is formed from the upper end to the lower end of the rotary shaft section 213 along the center of the rotary shaft 213a, and the wire L connected from the board 230 to the grip section 220 can pass through the through-hole 213b.

The switching section 214 is configured to receive the switching terminal pin 215 for performing a switching operation of selecting an operation mode through an on-off operation by a relative rotation of the head section 210 and the grip section 220. As shown, the switching section 214 has a connection hole 214a which the rotary shaft 213a is inserted into and connected to. The rotary shaft 213a is inserted into the connection hole 214a, and the switching section 214 is connected to the end portion of the rotary shaft 213a, such that it is integrally rotated with the rotary shaft section 213 by a key connection. In order to prevent the switching section 214 connected to the rotary shaft 213a from being released from the rotary shaft 213a, an E-shaped key is connected to an end portion of the rotary shaft 213a. Meanwhile, in the switching section 214, a pin hole 214b for receiving the switching terminal pin 215 is formed at one side of the connection hole 214b. A support plate 215b is electrically connected to one electrode of the battery 260 through a terminal plate 224 of the grip section 220 (which will be described below). The supply plate 215b is installed to block a lower entrance of the pin hole 214b.

The switching terminal pin 215 configures a contact point C that is to contact switch contact points C1, C2, C2′ and C3 provided in the shaft support section 222. The switching terminal pin 215 is integrally rotated with the head section 210 by a relative rotation of the head section 210 and the grip section 220, and is contacted with one of the switch contact points C1, C2, C2′ and C3. The switching terminal pin 215 is inserted into the pin hole 214b whose lower portion is blocked by the support plate 215b, and is disposed between the support plate 215b and the switching terminal pin 215. To this end, an upper end of the switching terminal pin 215 is elastically supported in an upwardly protruding direction by a pin support spring 215a inserted into the pin hole 214b. Therefore, the upper end of the switching terminal pin 215 is contacted with the shaft support section 222 provided with the switch contact points C1, C2, C2′ and C3.

A space for receiving the battery 260 is formed inside of the grip section 220, and the rotary shaft 213a provided in the head section 210 is connected to the grip section 220. The grip section 220 provides the switch contact points C1, C2, C2′ and C3 to be contacted with the switching terminal pin 215.

As shown, the grip section 220 includes grip section cases 221a and 221b, a shaft support section 222, an electric stimulus electrode section 223, a terminal plate 224, a connection ring 226, a grip section cover 227, and a terminal gap 228. The grip section cases 221a and 221b are vertically divided into halves to have an inclined plane 220′ contacting the inclined plane 210′ of the head section 210 at the upper end thereof. The shaft support section 222 is integrally connected to the grip section cases 221a and 221b such that the rotary shaft 213a is inserted into and supported by the shaft support section 222 at the upper end of the grip section cases 221a and 221b. The electric stimulus electrode section 223 has a surface exposed to the exterior of the grip section cases 221a and 221b and made of an electrically conductive material, and is connected to the grip section cases 221a and 221b. The terminal plate 224 has a terminal spring 224a and a terminal connection plate 224b. The terminal spring 224a contacting one electrode of the battery 260 received in the grip section cases 221a and 221b is installed on the bottom of the terminal plate 224, and the terminal connection plate 224b contacts the other electrode of the battery 260 received in the grip section cases 221a and 221b. The connection ring 226 tightens the connected state of the grip section cases 221a and 221b divided into halves. The grip section cover 227 covers the lower portions of the grip section cases 221a and 221b. The terminal cap 228 is connected to the inside of the grip section cover 227 such that the other electrode of the battery 260 received inside the grip section cases 221a and 221b is contacted with the terminal cap 228.

The grip section cases 221a and 221b are connected to the shaft support section 222 at the upper portion, and receive the battery 260 under the shaft support section 222. If the grip section cases 221a and 221b are vertically divided by halves and are connected by the connection ring 116, the inclined plane 220′ contacting the inclined plane 210′ of the head section 210 is formed at the upper portion in the connected state. An exposure hole 221c for mounting the electrode surface 223a of the electric stimulus electrode section 223 in an exposed manner is formed at one side of the grip section cases 221a and 221b to penetrate the inside and outside thereof. Shaft penetration holes 221d and 221d′ are formed at the upper portions of the grip section cases 221a and 221b. The rotary shaft 213a vertically penetrates through the shaft penetration holes 221d and 221d′ at the central portion of the inclined plane 220′.

The shaft support section 222 rotatably supports the rotary shaft 213a and provides the switch contact points C1, C2, C2′ and C3 to be contacted with the switching terminal pin 215. The shaft support section 222 is integrally connected to the upper ends of the grip section cases 221a and 221b. In the shaft support section 222, the shaft insertion hole 222a is formed such that the rotary shaft 213a is inserted and axially supported. A contact point board 222c is provided at one side of the shaft insertion hole 222a. The contact point board 222c is provided with a terminal pin slot 222b and the switch contact points C1, C2, C2′ and C3. The terminal pin slot 222b forms a passage through which the upper end of the switching terminal pin 215 passes. The switch contact points C1, C2, C2′ and C3 contact the end of switching terminal pin 215 inserted into the terminal pin slot 222b.

In order to apply the electric stimulus generated by the electric stimulus generating unit to the human body, the electric stimulus electrode section 223 has an electrode surface 223a made of an electrically conductive material in order for electrical connection to the surface of the head section 210. As shown, the electric stimulus section 223 is connected to the grip section cases 221a and 221b such that the electrode surface 223a is exposed to the exterior through the exposure hole 221c of the grip section cases 221a and 221b. The electrode surface 223a is connected one electrode of the two electrodes of the electric stimulus generating unit. If the user holds the grip section 220 with his or her hand H, contacts the surface of the head section 210 on his or her skin in order for electric stimulus and then contacts the electrode surface 223a with his or her hand, an electric current flows between the surface of the head section 210 and the electrode surface 223a through the user's body, and electric stimulus is applied to the user's body by the electric stimulus generating unit. Meanwhile, a terminal plate connection section 223b is formed at a lower portion of the electrode stimulus electrode section 223. The terminal plate 224 is connected to and supported by the terminal plate connection section 223b.

The terminal plate 224 is provided with a circuit for relaying a circuit in which the two electrodes of the battery 260 are connected to the switching terminal pin 215, the switch contact points C1, C2, C2′ and C3 and the board 230. As shown, the terminal plate 224 has a terminal spring 224a and a terminal connection plate 224b. The terminal spring 224a contacting one electrode of the battery 260 received in the grip section cases 221a and 221b is installed on the bottom of the terminal plate 224, and the terminal connection plate 224b contacts the other electrode of the battery 260 received in the grip section cases 221a and 221b. The terminal plate 224 is connected to the terminal plate connection section 223b provided in the electric stimulus electrode section 223 and is disposed above the battery 260. The terminal connection plate 224b elongates downward from the terminal plate 224 disposed above the battery 260 along the inner surface of the grip section cases 221a and 221b, is located under the battery 260, and is electrically contacted with the terminal cap 228 that contacts one electrode of the battery 260.

The lower ends of the grip section cases 221a and 221b are inserted into the connection ring 226. The connection ring 226 tightens the connected state of the grip section cases 221a and 221b vertically divided into halves.

The grip section cover 227 is connected to the lower ends of the grip section cases 221a and 221b to cover the lower ends of the grip section cases 221a and 221b.

The terminal cap 228 is connected to the inside of the grip section cover 227 by a fixing screw 228A, such that the other electrode of the battery 260 received inside the grip section cases 221a and 221b is contacted with the terminal cap 228.

Meanwhile, the vibration motor 240, the lamp 250 for skin stimulus, the electric stimulus generating unit, the contact point E1 of the surface of the head section 210, the contact point E2 of the electrode surface 223a of the grip section 220, the lamp 270 for mode display, the switching terminal pin 215, the switch contact points C1, C2, C2′ and C3, and the battery 160, which are provided on the board 230, are electrically connected as shown in FIGS. 12A and 12B. In particular, in the massage apparatus 200 for skin care according to the second embodiment of the present invention, if the head section 210 and the grip section 220 are relatively rotated, the contact point C of the switching terminal pin 215 is contacted with the switch contact points C1, C2, C2′ and C3, thereby establishing electrical connection. That is, referring to FIGS. 12A and 12B, one of the two electrodes of the battery 260 is connected to the board 230 disposed in the head section 210, and the other is connected to the switching terminal pin 215 through the support plate 215b and the pin support spring 215a by means of the circuit provided in the terminal plate 224 of the grip section 220. Therefore, the switching terminal pin 215 becomes the contact point C to be connected to the switch contact points C1, C2, C2′ and C3. The switching terminal pin 215 integrally pivoted with the head section 210 by the relative rotation of the head section 210 and the grip section 220 is connected to the switch contact points C1, C2, C2′ and C3 provided in the shaft support section 222 of the grip section 220. If the contact point C of the switching terminal pin 214 is connected to the switch contact point C3, the power is in an off state. If the contact point C of the switching terminal pin 214 is connected to the switch contact point C1, the circuit is formed in a first mode. Thus, the vibration motor 240, the lamp 250 for skin stimulus, the lamp 260 for mode display, and the electric stimulus generating unit are operated by the circuit provided on the board 230. If the contact point C of the switching terminal pin 214 is simultaneously connected to the switch contact points C2 and C2′, the circuit is formed in a second mode. Thus, the vibration motor 240, the lamp 250 for skin stimulus, the lamp 260 for mode display, and the electric stimulus generating unit are operated by the circuit provided on the board 230.

According to the exemplary embodiments, the massage apparatus for skin care is designed to be bent by its rotation, whereby a volume of the massage apparatus is reduced while a user carries it with him or her, and a user easily holds the massage apparatus and contacts a head on a user's face.

Moreover, since the massage apparatus is designed to perform a switching operation during the rotation for bending, a user need not operate the massage apparatus separately.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A massage apparatus for skin care, which has an elongated body and a head at one end of the body to apply a stimulus to a skin, characterized in that the body is divided into a head section in which the head is located, and a grip section opposite to the head section, along an inclined plane sloped with respect to a longitudinal direction of the body, and the head section and the grip section separated from each other are connected to be rotatable around a rotary shaft, which is provided in parallel to a normal direction of the inclined planes, in either or both of left and right directions, in a state that the inclined planes thereof contact each other.

2. The massage apparatus of claim 1, wherein the body has a circular cross-section, and the head section is formed by cutting an edge section formed by the inclined plane thereof and an outer plane that are met at an acute angle.

3. The massage apparatus of claim 1, wherein switch contact points are formed on the inclined planes of the head section and the grip section, such that the switch contact points are contacted and electrically connected by a relative rotation of the head section and the grip section.

4. The massage apparatus of claim 3, wherein the head section or the grip section includes a lamp for mode display, which emits light by the connection of the switch contact points.

5. The massage apparatus of claim 1, wherein the head section includes a vibrating unit for generating a vibration to the head section, and the head section applies a tapping stimulus to a skin by transferring the vibration generated by the vibrating unit to the skin.

6. The massage apparatus of claim 1, wherein the head section includes a lamp for skin stimulus, and light emitted from the lamp for skin stimulus is irradiated through a front end of the head section.

7. The massage apparatus of claim 1, wherein the head section or the grip section includes an electric stimulus generating unit,
partial or entire surfaces of the head section and the grip section are made of an electrically conductive material, and
the surfaces made of the electrically conductive material are connected to two electrodes of the electric stimulus generating unit.

8. The massage apparatus of claim 1, wherein the head section includes:
a lower section case in which the head is provided at a front end and a board is mounted thereinside; and
a rotary shaft section which is integrally connected to the head section case and in which an inclined plane contacting the inclined plane of the grip section is formed at an end portion thereof, the rotary shaft section including a rotary shaft protruding vertically with respect to the inclined plane,
wherein the grip section includes:
a grip section case having an inclined plane contacting the inclined plane of the head section at an upper end thereof; and
a shaft support section integrally connected to the grip section case such that the rotary shaft is inserted into and supported by the shaft support section at the upper end of the grip section case.

9. The massage apparatus of claim 8, wherein the head section further includes:
a switching unit connected to the rotary shaft section such that the switching section is integrally rotated with the rotary shaft section, the switching unit having a terminal pin receiving groove; and
a switching terminal pin received in the terminal pin receiving groove and having an end portion elastically supported in a protruding direction,
wherein the grip section has a surface through which the end portion of the switching terminal pin contacts and passes, at least one switch contact point being formed on the surface of the grip section.

10. The massage apparatus of claim 8, wherein the board includes a lamp for mode display, and the rotary shaft section is made of a material through which light generated from the lamp for mode display is transmitted.

11. The massage apparatus of claim 8, wherein the rotary shaft section has a through-hole vertically penetrating through the central portion of the rotary shaft, and a wire for connecting the head section and the grip section passes through the through-hole.
